(19) United States
(12) Patent Application Publication
(10) Pub. No.: US 2013/0099647 A1
(43) Pub. Date: Apr. 25, 2013

(54) SLIDING SWITCH AND FOLDING DEVICE

(71) Applicants: HE-LI WANG, Shenzhen City (CN); YUAN-MING WANG, Shenzhen City (CN); YONG-JUN YU, Shenzhen City (CN); WEI LIU, Shenzhen City (CN)

(72) Inventors: HE-LI WANG, Shenzhen City (CN); YUAN-MING WANG, Shenzhen City (CN); YONG-JUN YU, Shenzhen City (CN); WEI LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/517,696

(22) Filed: Jun. 14, 2012

(30) Foreign Application Priority Data
Oct. 19, 2011 (CN) 201110318495.9

(51) Int. Cl. E05C 19/10; A47B 96/00; E05C 1/12

(52) U.S. Cl. 312/327; 292/138; 292/164

(57) ABSTRACT

A sliding switch for fastening a first object to a second object includes a base, an operating member, and a cooperating member. The operating member is connected to one side of the base. The cooperating member is connected to the other side of the base. The cooperating member defines a gap and projects a grasping member, the grasping member capable of holding the second object. The gap enables the operating member located at the inside of the first object when the sliding switch is located at a first position with respect to the first object. The sliding switch can move to the second position with respect to the first object to enable the operating member to pass out of a slot defined in the second object located at the exterior of the first object. The first position is different from the second position.

### BACKGROUND

1. Technical Field

The present disclosure relates to switches, and particularly to a sliding switch and a folding device using a sliding switch.

2. Description of Related Art

Any folding device, such as a notebook computer, a portable DVD player, includes a main body, and a cover with one side rotatably connected to one side of the main body. One of the main body and the cover has a sliding switch, the other one of the main body and the cover has a hook. The hook and the sliding switch fasten together to enable the cover to be locked to the main body. The sliding switch includes an operating member and a sliding member. The operating member and the sliding part are independent. Therefore, the operating member and the sliding member are mounted to the main body or to the cover one by one when the sliding switch is mounted. Therefore, the assembly of the sliding switch becomes very complex.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a folding device.

FIG. 2 is a partially exploded view of the folding device in FIG. 1 from the inverted aspect, the folding device having a sliding switch.

FIG. 3 is an exploded view of the sliding switch in FIG.2.

FIG. 4 shows a closed state of the folding device in FIG. 1.

### DETAILED DESCRIPTION

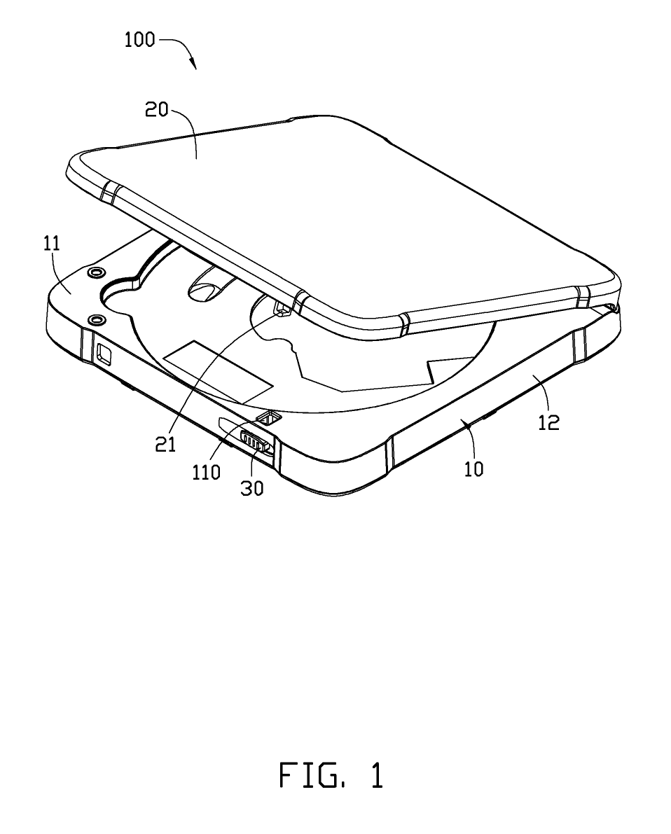

FIG. 1 shows a folding device 100. The folding device 100 is a portable DVD player in this embodiment. The folding device 100 includes a main body 10, a cover 20 rotatably connected to the main body 10 for covering the main body 10, and sliding switch 30 located in the main body 10.

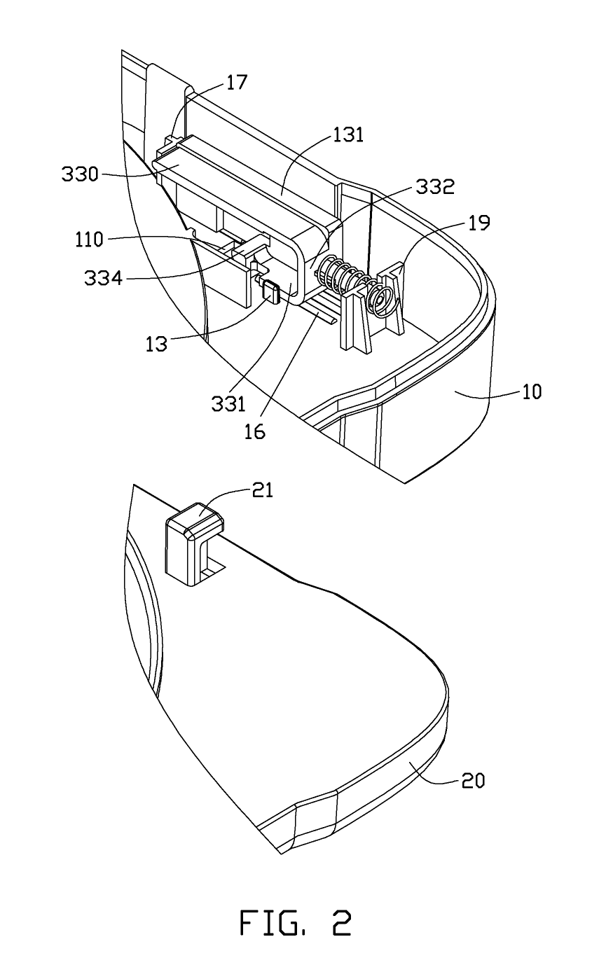

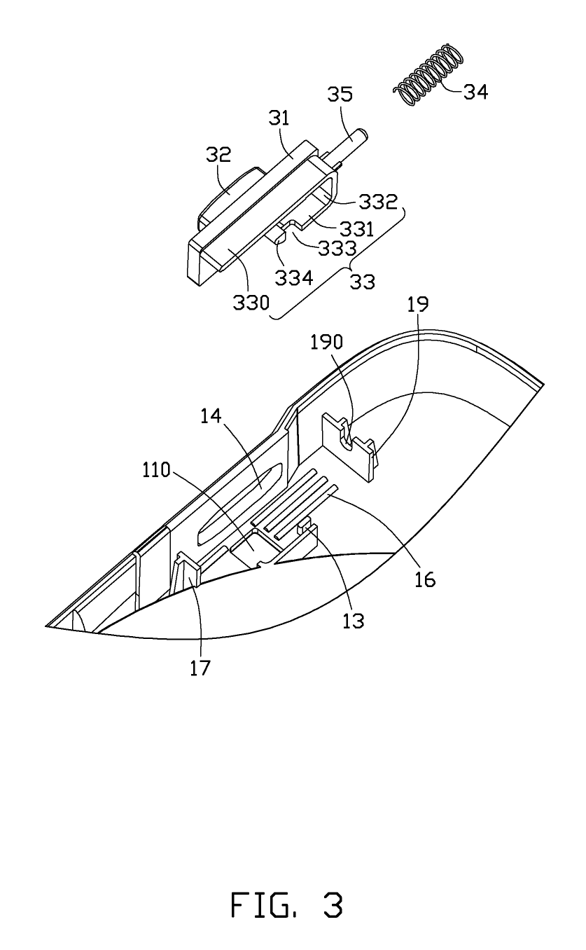

Referring to FIGS. 2 and 3, one side of the cover 20 is rotabably connected to the main body 10, a hook 21 projects from the other side of the cover 20. The hook 21 extends from the surface facing the main body 10. When the cover 20 closes on the main body 10, the hook 21 and the sliding switch 30 are fastened together thus the cover 20 is held closed on the main body 10.

The sliding switch 30 is mounted in the main body 10, and arranged on a side of the main body 10 corresponding to the position of the hook 21. The sliding switch 30 includes a base 31, an operating member 32, and a cooperating member 33 arranged on opposite sides of the base 31, a guiding member 35 extending from the cooperating member 33, and an elastic member 36 is secured to the guiding member 35. The base 31, the operating member 32, the cooperating member 33, and the guiding member 35 are integral.

The base 31 is a rectangular board. The operating member 32 is located in the middle of the base 31. The cooperating member 33 includes an enhancing part 330, a sliding part 331, a joining part 332, a gap 333, and a clasping part 334. The enhancing part 330, the sliding part 331, and the joining part 332 protrude substantially perpendicularly from the base 31. The gap 333 is defined in the sliding part 331. The clasping part 334 is positioned on the sliding part 331.

The enhancing part 330, the sliding part 331 and the joining part 332 constitute a rectangular board. The enhancing part 330 and the sliding part 331 are parallel to each other. The length of the enhancing part 330 is substantially equal to the length of the base 31. The length of the sliding part 331 is shorter than the length of the enhancing part 330. The sliding part 331 extends from one end of the enhancing part 330 to the middle of the enhancing part 330. The joining part 332 is connected to the ends of the sliding part 331 and the enhancing part 330. The clasping part 334 is located on the end of the sliding part 331, and extends toward the enhancing part 330. The gap 333 is defined in the sliding part 331 and adjacent to the grasping member 333. The gap 333 runs from one edge of the sliding part 331 away from the base 31 to the middle of the sliding part 331. Perpendicular to the sliding direction of the sliding switch 30, the width of gap 331 is equal to the thickness of the operating member 32.

The guiding member 35 extends from the joining part 12 and away from the clasping part 334. The guiding member 35 is columnar, and the axis of the guiding member 35 is parallel to the sliding direction of the sliding switch 30. The elastic member 34 is a spring, and is sleeved on the guiding member 35.

The main body 10 includes a rectangular top 11, and a side wall 12 around and extending downwardly from the rectangular top 11. The main body 10 further includes a slot 14 defined in the side wall 12 away from the side of the main body 10 connected to the cover 20. The sliding switch 30 is located at one surface of the top 11 which is away from the cover 20, and the operating member 32 extends out of the slot 14. The slot 14 is large enough so that the operating member 32 is capable of moving from one end to the other end of the slot 14.

The main body 10 further includes a hole 110 defined in the top 11, and a blocking member 13, a plurality of parallel ribs 16, a stopping member 17, and a restriction member 19 arranged on a surface of the top 11 away from the cover 20. The stopping member 17 and the restriction member 19 are connected to the side wall 12 and located on opposite sides of the slot 14. The hole 110, the blocking member 13, and the ribs 16 are positioned between the stopping member 17 and the restriction member 19.

The hole 110 is configured to allow the hook 112 to pass through. The hole 110 is rectangular and extends from a center line of the slot 14 toward the stopping member 17. The ribs 16 are columnar and arranged between the hole 110 and the restriction member 19. Each rib 16 runs from a position which is adjacent to the hole 110 toward the restriction member 19. The blocking member 13 protrudes from the top 11 and is adjacent to one rib 14 away from the slot 14, and deviates from the center line of the slot 14. The blocking member 13 is capable of passing through the gap 333. Perpendicular to the sliding direction of the sliding switch 30, the distance between the blocking member 13 and the side wall 12 is equal to the sum of the thickness of the base 31 and the sliding part 331. The stopping member 17 and the restriction member 19 are rectangular boards. A sliding groove 190 is inset at the end of the restriction member 19.

When the sliding switch 30 is to be secured to the main body 10, first, the sliding switch 30 is placed between the stopping member 17 and the restriction member 19 with operating member 32 being adjacent to the slot 14, and the blocking member 13 is passed through the gap 333 (at this time, the sliding switch 30 is located at a first position with respect to the main body 10), and sliding part 331 with its side away from the base 31 is put in contact with the blocking member 13, as a result, the whole sliding switch 30 is received in the main body 10; second, the sliding switch 30 is moved toward the slot 14 until the operating member 32 passes through the slot 14 to be located at the exterior of the main body 10 (at this time, the sliding switch 30 is located at a second position with respect to the main body 10). The blocking member 13 is separated from the gap 333. Third, the guiding member 35 is located at the guiding groove 190, and the sliding switch 30 is moved to the stopping member 17 until the sliding switch 30 contacts the stopping member 17. Opposite ends of the elastic member 34 contact the joining part 332 and the restriction member 19, the grasping part 334 is located in the hole 110, the base 31 and the sliding part 331 are sandwiched between the side wall 12 and the block member 13, and the sliding part 331 is located at the ribs 16. The sliding switch 30 is now secured to the main body 10. When an external force, such as with a fingertip, is exerted on the operating member 32, the operating member 32 moves along the slot 14 and enables the sliding part 331 to move. The blocking member 13 separates from the gap 333 as the operating member 32 moves along the slot 14.

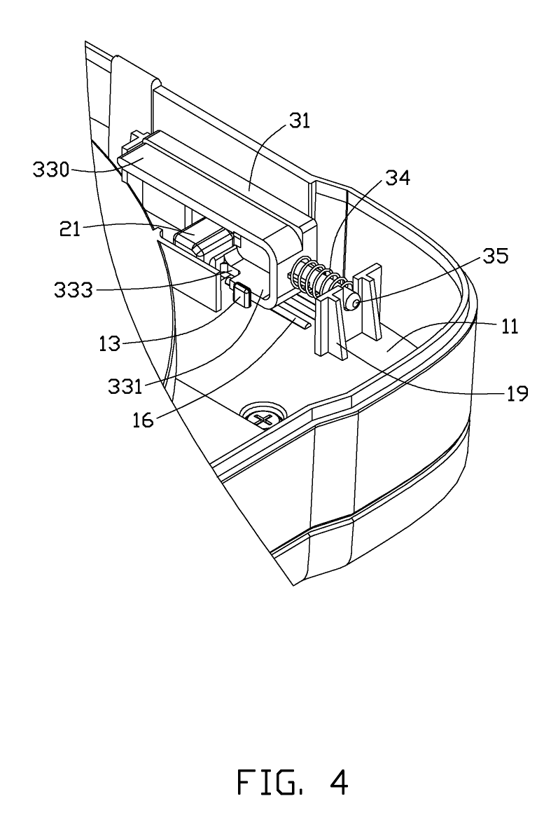

In operation, referring to FIG. 2, the cover 20 is folded down to cover the main body 10, and the hook 21 passes through the hole 110 to engage with the grasping member 334. Thereby, the cover 20 is secured to the main body 10. Further referring to FIG. 4, an external force is exerted on the operating member 32 to move the sliding switch 30 towards the restriction member 19, the grasping member 334 is also moved to the restriction member 19, at the same time, the elastic member 34 is compressed to generate an elastic force which will drive the switch member 30 back; the switch 30 moves a distance and the grasping member 334 separates from the hook 21. The cover 20 is thus released from the main body 10, and if the force is removed from the operating member 32, the sliding switch 30 moves back to its original position because of the elastic force provided by the elastic member 34.

It is to be understood, however, that even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A sliding switch for fastening a first object to a second object, the sliding switch is slidably mounted to the first object, the sliding switch comprising:
a base with opposite sides;
an operating member connected to one side of the base; and
a cooperating member connected to the other side of the base, a gap defined in the cooperating member, a grasping member protruding from the cooperating member, the grasping member capable of fastening the second object;
wherein the gap allows the operating member to be located inside of the first object when the sliding switch is located at a first position with respect to the first object; the sliding switch is capable of moving to the second position with respect to the first object to allow the operating member to pass through a slot defined in the first object to locate at the exterior of the first object, the first position is different from the second position; the operating member is capable of moving along the slot to drive the base and the cooperating member to move with respect to the first object so as to enable the grasping member to fasten or unfasten the second object.

2. The sliding switch of claim 1, wherein the cooperating member further comprises a sliding part connected to the base, the sliding part is capable of sliding on the first object, the grasping member is arranged at one end of the sliding part, the gap is defined in the sliding part and is adjacent to the grasping member.

3. The sliding switch of claim 1, further comprising a guiding part, and an elastic member secured to the guiding part, the guiding part being integral with the cooperating member, one end of the elastic member contacts the cooperating member, the other end of the elastic member contacts the first object, when the operating member moves, the elastic member being capable of deforming to generate an elastic force to enable the operating member to return to its original position.

4. The sliding switch of claim 1, wherein the thickness of the operating member is equal to the width of the gap taken along the thickness direction of the operating member.

5. The sliding switch of claim 1, wherein the base is integral with the operating member, and the cooperating member.

6. A folding device comprising:
a main body having a top and a side wall protruding from the top, the side wall defining a slot;
a cover rotatably connected to one side of the main body away from the side wall, the cover having a hook, the cover being capable of covering on the main body; and
a sliding switch slidably mounted to the main body, the sliding switch comprising
a base with opposite sides;
an operating member connected to one side of the base; and
a cooperating member connected to the other side of the base, the cooperating member defining a gap and projecting a grasping member, the grasping member capable of fastening the hook when the cover covers on the main body;
wherein the gap allows the operating member to locate inside of the side wall when the sliding switch is located at a first position of the top; the sliding switch is capable of moving to the second position of the top to enable the operating member to pass through the slot to locate at the external side of the side wall, the first position is different from the second position; the operating member is capable of moving along the slot to drive the base and the cooperating member to move with respect to the top, as to enable the grasping member to fasten or unfasten the hook.

7. The folding device of claim 6, wherein the main body further comprising a blocking member, the blocking member protruding from the top, when the sliding switch is located at the first position, the blocking member is inserted in the gap, when the sliding switch is located at the second cooperation member, the block member is separated from the gap.

8. The folding device of claim 7, wherein the blocking member is kept separating from the gap during the operating member moves along the slot.

9. The folding device of claim 6, wherein the cooperating member further comprises a sliding part connected to the base, the sliding part is capable of sliding on the first object, the grasping member is arranged at one end of the sliding part, the gap is defined in the sliding part and is adjacent to the grasping member.

10. The folding device of claim 6, further comprising a guiding part, and an elastic member secured to the guiding part, the guiding part being integral with the cooperating member, one end of the elastic member contacts the cooperating member, the other end of the elastic member contacts the first object, when the operating member moves, the elastic member being capable of deforming to generate an elastic force to enable the operating member to return to its original position.

11. The folding device of claim 6, wherein the base is integral with the operating member and the cooperating member.
